(19) United States
(12) Patent Application Publication
(10) Pub. No.: US 2011/0117252 A1
(43) Pub. Date: May 19, 2011

(54) Process for the preparation of tetrahydroisohumulone compositions

(75) Inventors: Brian Patrick Buffin, (US); Joshua James Tuinstra, (US); Peter Collins Vanalstyne, (US); Elizabeth Barren, (US); Paul H. Todd, JR., (US); James Melvin, (US); Bradley Weller, (US)

(73) Assignee: KALAMAZOO HOLDINGS, INC.

(21) Appl. No.: 12/927,277

(22) Filed: Nov. 10, 2010

Related U.S. Application Data
(60) Provisional application No. 61/281,169, filed on Nov. 13, 2009.

(51) Int. Cl. C12H 1/14; C12C 3/00

(52) U.S. Cl. 426/271; 426/600

(57) ABSTRACT

A process for preparing tetrahydroisohumulone compositions from a hop extract, which process provides an improvement over the extant art, and provides a tetrahydroisohumulone preparation of high yield and purity, which tetrahydroisohumulone preparation exhibits excellent physical stability, and is essentially free from undesirable lupulones, fatty acids, hop oils and degradation compounds.

### FIELD OF INVENTION

The present invention relates to a process that provides an improvement over the extant art and provides a tetrahydroisohumulone preparation, derived from a hop extract, with high yield and purity, which tetrahydroisohumulone preparation has excellent physical stability and is essentially free from undesirable lupulones, fatty acids, hop oils, and degradation compounds. Tetrahydroisohumulones, from said process, are light-stable bittering and foam-stabilizing agents used in the brewing of beer or related industries.

### BACKGROUND OF THE INVENTION

The production of beer and other brewed beverages has traditionally involved the addition of hops and hop derivatives thereto. Hop materials impart a distinctive, bitter flavor to brewed beverages. The primary bittering ingredients in hop cones involve materials known as humulones (alpha acids or α-acids). In beer brewing, hops are boiled with wort at a pH value around 5.5. Under these conditions, the hop humulones are poorly soluble, but during the process some of the humulones are transformed by isomerization into derivatives, known as isohumulones (isoalpha acids or iso-α-acids), which consists of a mixture of species known as cis- and trans-isomers and are bitterer and more soluble in the wort medium. Consequently, to be used efficiently in the production of brewed beverages as bittering agents, the foregoing humulones must be isomerized to isohumulones.

There are numerous methods by which the isomerization of humulones in hop materials may be achieved. For example, boiling the hop materials in highly alkaline solution will result in isomerization. However, when this process is used, degradation of isohumulones takes place, especially when the pH exceeds 9.5. Degradation occurs due to the fact that isohumulones are particularly unstable in strong alkaline conditions (Verzele, 1991).

U.S. Pat. No. 4,666,731 claims a process that separates the humulones using less than 0.98, and preferably 0.85, equivalents of base relative to humulones, said base selected from sodium and potassium hydroxides, bicarbonates, and carbonates. The alkaline solution is autoclaved at 120° C. for 2.5 hours or exceptionally longer at lower temperatures. Higher temperatures may be used but results in increased degradation of the humulones. This process provides low utilization of humulones, perhaps in part due to the low equivalent amount of base used relative to humulones in the initial separation from the extract (see Example 1). It also requires higher temperatures and longer reaction time than the present invention due to the fact that an alkaline earth metal salt, which is capable of catalyzing the isomerization, is not used.

U.S. Pat. No. 4,758,445 describes a process that consists of mixing hop extract with alkaline aqueous solution in a ratio of 1:2 to 1:50 (pH approximately 9.0) and stirring at elevated temperatures to obtain a two-phase system in which the quasi-aqueous phase containing dissolved humulones is separated. The humulones are precipitated from the aqueous phase by addition of magnesium chloride that forms a chelate with the humulones. This process is repeated multiple times to maximize yield. The alkaline earth metal humulates are collected by filtration, spread as a thin layer on a plate, and isomerized by subjecting them to elevated temperature of around 100° C. and humidity of 90-98% for a period of 5 minutes to 6 hours. The isomerized magnesium isohumulates are diluted in ethanol to approximately a 10% solution, acidified, and subjected to reverse osmosis, providing an isohumulone that is then diluted with ethanol to the desired isohumulone concentration. This process employs solid handling procedures, separation techniques and specific isomerization conditions that are not required in the present invention.

U.S. Pat. No. 3,952,061 claims a process that isomerizes humulone containing material in a medium of water and a water miscible organic solvent, such as methanol or ethanol, with one molar equivalent of a salt such as magnesium chloride. This process uses water miscible organic solvents and crystallization techniques using isooctane extracts of ethereal solutions to purify isohumulones that are not needed in the present invention.

U.S. Pat. No. 5,015,491 claims a process that isomerizes hop extract, using no solvents or diluents, with a solid alkali or alkaline earth metal compound, preferably 1-4 molar equivalents of base to alpha acids, at temperatures preferably in the 120°-140° C. range. This process uses high temperatures with short contact times to produce a highly viscous or brittle solid that can be ground into a fine powder to be used in beer brewing. This process does not employ an isolation technique to purify the isohumulones from the hop extract. The impurities such as fatty acids, lupulones, alkaline earth metal salts and degradation products can produce stability issues in the final beer product in the form of solids, haze and possible undesired flavors that are not encountered when using the present invention.

U.S. Pat. No. 5,370,897 claims a process that combines hop extract with 1.0-4.0 volumes of warm water and isomerizes with 0.1-0.5 molar equivalents of alkaline earth salt per mole of alpha at a temperature greater than 70° C. for 1-3 hours. The alkaline earth resin complex is disassociated by the addition of an acid and the organic layer that forms is used for brewing processes. This process does not employ a purification process to isolate the isohumulones from the rest of the extract. The resulting organic layer includes lupulones, fatty acids and degradation products that are undesirable in the final beer product.

U.S. Pat. No. 5,478,580 claims an aqueous process that combines hop extract, deionized water and a metal salt isomerizing agent in powder form with a weight ratio of 0.2:1 to 0.5:1, isomerizing agent to hop extract. Preferred isomerizing compounds for this process include MgO, Mg(OH)₂, ZnO, Zn(OH)₂, CaO, Ca(OH)₂, and NaOH. The reaction mixture is boiled to complete isomerization and then treated with multiple acid washes at reflux followed by partitioning to free the isohumulones from the metal chelate. This process then uses multiple alkaline pH partitions to isolate the isohumulones from the lupulones and hop oils before being washed with acid again to further purify the isohumulones. The resulting isohumulones in acid form are then diluted with a controlled amount of a monovalent alkaline salt of sodium or potassium, and the resulting solutions can be used in brewing processes. This process isomerizes and acidifies the hop extract prior to isohumulone isolation, which will greatly affect the types and amounts of impurities, such as fatty acids and residual alpha acids, which end up in the final extract. These types of impurities are minimized in the present invention, by separating the humulones away from the other extract ingredients prior to isomerization, thereby limiting the types and amounts of impurities that make their way into the beer. The process described in U.S. Pat. No. 5,478,580 also requires multiple washes under various pH conditions at high temperature. These cumbersome processes are minimized or avoided with the present invention, which also has the advantage of reducing the amounts of discarded waste streams and salts formed by multiple acid-base dilutions.

U.S. Pat. No. 4,234,516 covers the direct isomerization of humulone or humulone-containing material at elevated temperature and a pH below 9 using a divalent metal ion. Metal catalysts discussed include Zn, Mg, Ca, Ba, Sr, Mn, as well as anions such as acetate, sulfate, and chloride. Their process does not disclose a step wherein the humulone input is separated and purified from the beta acids prior to isomerization. They do report high yields of isohumulones, but they do not specifically discuss purities. Additionally, many of the examples also crystallize the product to purify it, which is not needed in the instant process to obtain high purity isohumulone products.

GB 1,424,785 describes alkaline earth metal compounds as well as zinc oxide and zinc carbonate as isomerization agents. This patent describes a process for isomerizing the alpha acids in a hop extract utilizing divalent metals in a biphasic solution of a water-immiscible solvent and a water-miscible solvent. They do not isolate alpha acids from the hop extract prior to isomerization. No mention is made of pH control to minimize degradation, nor removal of fatty acids to achieve the product purity necessary to have physical stability of a resulting isohumulone solution in water at pH 9.0 to 10.0. They claim isolation of the isoalpha acids after isomerization by contacting a water-immiscible solvent containing the isoalpha acids with aqueous alkali at pH sufficient to transfer the isoalpha acids into the aqueous phase as their alkali metal salts, but not sufficient to transfer the majority of the beta acids into the aqueous phase. The instant process, on the other hand, removes the majority of the beta acids prior to isomerization, and removes the last traces of beta acids after isomerization via isohexanes/aqueous caustic partitioning. It has been found that removal of beta is critical to physical stability, particularly at low temperatures (−0° C.).

Isohumulones, while relatively stable, undergo a rapid chemical decomposition when exposed to light in the presence of a photo-sensitizer. Unstable radicals generated in this photochemical reaction react with natural sulfur compounds found in brewed beverages to generate 3-methyl-2-butene-1-thiol (MBT), which is responsible for the well known “sunstruck” or “skunky” flavor in beer. Brewers that package beer in clear or green glass bottles are particularly at risk to develop this typically undesirable flavor.

Chemical reduction of either the carbon-carbon double bond or the carbonyl group of the isohexanoyl side chain in isoalpha acids is a known method to prevent the formation of MBT. Thus, light-stable reduced isohumulones are commercially available in the form of dihydro (rho) isoalpha acids, tetrahydroisoalpha acids (THIAA, tetrahydroisohumulones, tetrahydroiso-α-acids), and hexahydroisoalpha acids (HHIAA, hexahydroisohumulones).

The use of a transition metal to catalyze the hydrogenation of an olefinic (alkene) unsaturated hydrocarbon is a ubiquitous reaction that dates to the late 1800s. It is this specific chemical transformation that defines the conversion of isoalpha acids (isohumulones) to tetrahydroisoalpha acids via addition of 2 moles of hydrogen gas as depicted in FIG. 1 for the n-congener of isoalpha acid.

The hydrogenation of hop acids to produce tetrahydroisohumulones was first reported in 1947 (Verzele et al.) and later confirmed and further refined in 1959 (Brown et al.). This metal-catalyzed transformation is discussed in many literature reviews and books and is considered by those skilled in the art as the standard process of generating the light-stable modified hop bittering agent tetrahydroisohumulones (Hay and Homiski, 1991; Verzele, 1986; Moir, 2000; Verzele and DeKeukeleire, 1991).

Numerous methods exist for the formation of tetrahydroisohumulones including: (1) hydrogenolysis of lupulones (beta acids) followed by oxidation of the resulting desoxytetrahydroalpha acids and isomerization, (2) hydrogenation of humulones (alpha acids) and subsequent isomerization of the resulting tetrahydrohumulones, and (3) direct hydrogenation of isohumulones.

U.S. Pat. No. 3,552,975 describes the formation of desoxytetrahydro-α-acids via hydrogenolysis of lupulones using hydrogen and a transition metal catalyst. These intermediate species are subsequently oxidized with peracetic acid to tetrahydro-α-acids followed by isomerization to produce tetrahydroiso-α-acids. While able to employ typically lower value beta-acids, this method requires high levels of organic solvents, oxidizing acids, and suffers from an overall low yield of tetrahydroisohumulones.

U.S. Pat. No. 5,296,637 claims the hydrogenation of humulones as alkaline metal salts in aqueous or alcoholic solutions using hydrogen gas and a supported metal catalyst. Further isomerization of the resulting tetrahydro-α-acids affords the desired tetrahydroisohumulones.

U.S. Pat. No. 5,523,489 describes the preparation of tetrahydroisohumulones from isohumulones by hydrogenating the isohumulones in a reaction solvent of ethanol containing up to about 15% water in the presence of about 1 to 40 psig of hydrogen and a palladium on carbon hydrogenation catalyst. The amount of water in the reaction solution is deemed critical to prevent the formation of neotetrahydroisohumulone byproduct, in which a side chain carbonyl has been reduced. However, it is also stated that higher water content will decrease the overall catalytic activity of the solution to unacceptable levels. Low catalytic activity can lead to incomplete hydrogenation and the presence of partially-hydrogenated dihydroisohumulones or residual isohumulones in the final product, which must be avoided. Hydrogenation of isohumulones is performed at a pH of 1 to 7 following isolation of humulones from a CO₂ hop extract and isomerization with magnesium.

U.S. Pat. No. 5,767,319 describes the preparation of tetrahydroiso-α-acids from iso-α-acids metal salts. The iso-α-acids salts are dissolved in a lower alkanol, preferably ethanol, to provide a reaction solution that is roughly 5-20% water by mass. It is claimed that the amount of water in the reaction medium is critical to both the hydrogenation of the iso-α-acids and subsequent processing. In each of the examples, magnesium ion addition produces a chelate of the iso-α-acids that is subsequently hydrogenated at a hydrogen pressure of 5-50 psig and a temperature of approximately 30-50° C. The importance of magnesium ions in regulating the hydrogenation, thus preventing under- and over-hydrogenated product, is a critical teaching of this patent. Following hydrogenation, acid is employed to dissociate the resulting tetrahydroiso-α-acids from coordination to the divalent metal ion. The resulting acid-form tetrahydroiso-α-acids are then separated from the aqueous solution as an oil before formulation into an alkaline aqueous solution. Claims are not made regarding the concentration of the iso-α-acids, the amount of alcohol solvent, or the specific pH of the solution subjected to hydrogenation.

U.S. Pat. No. 5,874,633 discloses the formation of a concentrated single phase aqueous solution of tetrahydroiso-α-acids having greater than 10% to about 45% w/w tetrahydroiso-α-acids. A method of formulating an alkaline starting solution of iso-α-acids and their subsequent hydrogenation is also described. The primary claim involves dissolving an aqueous alkaline solution of iso-α-acids in a lower alcohol, reducing the iso-α-acids in the presence of 1-2000 psig of hydrogen with a Pd/C catalyst at a pH of 6-10, filtering the solution to remove the catalyst, and removing the alcohol to afford an aqueous alkaline solution of tetrahydroiso-α-acids of between 10% and 45% concentration by mass.

U.S. Pat. No. 5,600,012 describes the direct conversion of free acid-form iso-α-acids (IAA) to tetrahydroiso-α-acids (THIAA) via hydrogenation of an ethanol solution. The hydrogenation uses particular and specified types of noble metal catalysts containing Pd to control the hydrogenation and selectively produce THIAA without over-hydrogenation to undesirable perhydrogenation products.

U.S. Pat. No. 6,198,004 claims a process for converting alpha acids and isoalpha acids into tetrahydroisoalpha acids. The process involves the isomerization of alpha acids with magnesium to produce isoalpha acids and hydrogenation of the isoalpha acids with a noble metal catalyst, where the catalyst is added incrementally or continuously throughout the hydrogenation step. Isoalpha acids are hydrogenated in an aqueous solution with hydrogen pressures of 50 or 120-150 psig, although the use of other protic solvents and higher pressures are also claimed. The incremental catalyst addition is said to allow hydrogenation of isoalpha acids with high sulfur content.

U.S. Pat. No. 5,013,571 describes a method of converting hop alpha acids to tetrahydroisoalpha or hexahydroisoalpha acids by exposing the alpha acids to an environment that is capable of simultaneously isomerizing and reducing the hop alpha acids. Another aspect of the invention describes the conversion of isoalpha acids or dihydroalpha acids to tetrahydroisoalpha acids, hexahydroisoalpha acids, or a mixture thereof in either protic or aprotic solvents. The primary claim is the simultaneous isomerization and hydrogenation of alpha acids using H₂ and a noble metal catalyst for the hydrogenation and an alkaline earth metal to promote isomerization. The hydrogenation of isoalpha acids in either water, as the salt form at a pH of 5 to 12, or in chlorinated hydrocarbons as the free acid form is also described.

U.S. Pat. No. 6,020,019 describes the use of carbon dioxide as a solvent for the hydrogenation of hop soft resins. The carbon dioxide is preferably a liquid or supercritical fluid. The method is used to prepare tetrahydroiso-α-acids from alpha acids, iso-α-acids, or beta acids. The primary claim is a method for the hydrogenation of alpha acids, iso-α-acids, or beta acids by combining the compound of interest with hydrogen, a catalyst, and carbon dioxide to form a reaction mixture. Heating of the mixture under pressure is then used to promote reaction of the compounds with hydrogen gas.

U.S. Pat. No. 6,303,824 discloses a method of preparing tetrahydroiso-α-acids from iso-α-acids, wherein the reaction medium is a buffered aqueous alcoholic solution. The method claims an advantage in the use of up to 85% by mass spent catalyst. It is also claimed that buffering the solution of iso-α-acids improves both the purity and yield of the tetrahydroiso-α-acids that are formed in the hydrogenation reaction. The solution is buffered up to a pH of 10, but the most preferred range is described as between pH 3.0 to 4.0. The hydrogenation may be performed from 0 to 100° C. with hydrogen pressures up to 200 psig, including a temperature between 50-60° C. and 10 to 50 psig of hydrogen.

U.S. Pat. No. 7,344,746 describes a method of directly hydrogenating hop resin acids in the absence of a liquid organic solvent by heating to a temperature at which the resin acids are sufficiently fluid to allow easy mixing with a hydrogenation catalyst. Alternatively, carbon dioxide is used to bring about the necessary fluidity. The conversion of iso-α-acids to tetrahydroiso-α-acids and the conversion of rho-iso-α-acids to hexahydroiso-α-acids are claimed by this process.

### OBJECTS OF THE INVENTION

It is an object of the invention to provide an improved process of preparing a composition of purified tetrahydroisohumulones from hop extracts, said tetrahydroisohumulones being essentially free from undesirable lupulones, fatty acids, hop oils and degradation compounds.

It is another object of the present invention to avoid the disadvantages of prior art methods, such as described hereinabove.

It is still another object of the present invention to isolate the humulones from hop extract prior to further processing in a manner that allows the remaining valuable hop chemicals, such as lupulones and hop oils, to be reserved largely unchanged and therefore useful for other purposes.

It is still another object of the present invention to provide a process for the rapid, gentle production of isohumulones using alkaline earth metal salts to accelerate the reaction process.

It is still another object of the present invention to provide purified isohumulones from hop extract in high yields and purities by isolating the humulones from hop extract, isomerizing said humulones in an accelerated manner by use of zinc or alkaline earth metal salts, and purifying the isomerized isohumulones.

It is still another object of the present invention to provide a process for the purification of isohumulones.

It is still another object of the present invention to provide a tetrahydroisohumulone product from purified isohumulones in high yields (>90%) and purities (>90%) by hydrogenation of an alcoholic solution of isohumulones with hydrogen using a supported palladium catalyst, for example an oxidic palladium catalyst, removing the catalyst via filtration, recovering solvent alcohol through distillation, and formulating light-stable tetrahydroisohumulones into a product suitable for brewing or other purposes.

### BRIEF SUMMARY OF THE INVENTION

What we therefore believe to be comprised by our invention may be summarized inter alia in the following words:

A method for preparing a purified tetrahydroisohumulone composition, comprising the steps of:
a. dissolving a hop extract comprising humulones in a water-immiscible solvent and mixing in 0.7-1.1 molar equivalents, relative to humulone concentration, of an aqueous alkaline solution at a temperature of 35-45° C. to form a two phase separation;
b. recovering a humulone-enriched aqueous layer and optionally adjusting the pH to 8.6-9.0 with an aqueous alkaline solution;
c. heating the humulone-enriched aqueous layer under an inert atmosphere and adding a divalent metal compound as an isomerizing agent at or before solution reflux;
d. maintaining the aqueous mixture at or below reflux temperature under an inert atmosphere until isomerization of humulones to isohumulones is complete;
e. cooling the aqueous mixture to 60-90° C.;
f. adding 0.9-1.2 molar equivalents, relative to isohumulones, of an aqueous solution of an acid at 60-90° C. for 0.5-2.0 hours under an inert atmosphere;
g. cooling resulting mixture to 30-45° C. and adding a water-immiscible organic solvent;
h. stirring the solution, and then separating the organic and aqueous phases;
i. recovering the organic phase, and washing with water by adding water, stirring and separating the phases;
j. optionally, repeating step (i) to remove ionic species;
k. recovering the organic phase and mixing it with 0.25-1 volume of water, warming the mixture to 30-45° C., adjusting the pH to 6.7-7.0 with an alkaline solution, with stirring, and then separating the phases;
l. recovering, desolventizing and concentrating the aqueous layer containing the purified isohumulones;
m. optionally, removing the water-immiscible solvent at step (j) under reduced pressure;
n. adding a lower alcohol solvent to the resulting isohumulones;
o. adjusting the pH of the alcoholic isohumulone solution to 7.5-11 with an aqueous alkaline solution, such that the concentration of water in the reaction medium is greater than 30%;
p. adding 2-7% by dry mass, relative to the mass of isohumulones, of a supported palladium hydrogenation catalyst (5% Pd, wet form) to the alkaline aqueous/alcohol solution of isohumulones;
q. stirring the solution in the presence of 15-100 psig of hydrogen gas at a temperature of 35-60° C. for 1-6 hours;
r. releasing hydrogen pressure and recovering the reaction solution by removing the hydrogenation catalyst via filtration;
s. removing the alcohol solvent from the reaction solution and concentrating the tetrahydroisohumulone solution through distillation; and
t. adjusting the pH and concentration of the tetrahydroisohumulone solution with an aqueous alkaline solution to a final pH of 9.0-11.0 and to a desired concentration while stirring; such a

method wherein the hop extract is from cones of hop plants of the genus Humulus, such a

method wherein the hop cones are extracted by means of solvent extraction or supercritical fluid extraction or any other extraction means known to those skilled in the art, such a

method wherein the water-immiscible solvent is a hydrocarbon solvent, such a

method wherein the hydrocarbon solvent is isohexane, such a

method wherein the isohexane is a mixture of saturated hydrocarbons, predominantly of the formula C₆H₁₄, with a boiling point range of about 65 to 71° C., where the major isomers are n-hexane and 2-methylpentane, such a

method wherein the water-immiscible solvent is a mixture of hydrocarbons, such a

method wherein the water-immiscible solvent is a mixture of hydrocarbons which are predominantly composed of six carbons and varying in their weight ratios, relative to each other, such a

method wherein the volume ratio of hop extract comprising humulones to solvent in step (a) ranges from 0.5-3.0, such a

method wherein said aqueous alkaline solution is selected from one or more of hydroxides of sodium or potassium, such a

method wherein the aqueous alkaline solution is potassium hydroxide, such a

method wherein the divalent metal isomerization catalyst is selected from oxides, hydroxides, sulfates, chlorides, and acetates or other carboxylates, of Mg, Ca, and Ba, and combinations thereof, such a

method wherein the divalent metal isomerization catalyst is selected from zinc oxide, zinc hydroxide, zinc sulfate, zinc chloride, zinc acetate or other carboxylate, and combinations thereof, such a

method wherein the divalent metal isomerization catalyst is MgSO₄ or any of its hydrated forms, such a

method wherein the aqueous solution of an acid is added in a range of 0.9-1.1 molar equivalents to isohumulone at 60-90° C. for 0.5-2.0 hours under an inert atmosphere, when the isomerization agent is a magnesium compound, such a

method wherein the acid is selected from HCl, H₃PO₄ and H₂SO₄, such a

method wherein the acid is H₂SO₄, such a

method wherein an isohumulone-metal chelate is formed at step (d), and wherein the isohumulone-metal chelate is separated from solution prior to adding the acid, such a

method where in step (l), the isohumulones are desolventized by vacuum distillation or any other form of desolventizing known to those skilled in the art to levels of solvent suitable for human consumption, such a

method wherein the recovery yield of starting hop extract humulones to the resulting isohumulones is greater than 70%, such a

method wherein the recovery purity of the resulting isohumulones is greater than 90%, such a

method wherein the purified isohumulones are reduced via hydrogenation to afford purified tetrahydroisohumulones, such a

method wherein the isohumulones are hydrogenated as an alkaline solution of isohumulate salts, such a

method wherein the isohumulate is a potassium salt, such a

method wherein a lower alcohol is added to the isohumulate solution prior to hydrogenation, such a

method wherein the alcohol is either methanol or ethanol, such a

method wherein the alcohol is methanol, such a

method wherein the alcohol is ethanol, such a

method wherein a mixture of lower alcohols is added to the isohumulate solution prior to hydrogenation, such a

method wherein the mixture of lower alcohols is composed of ethanol, methanol, and isopropanol with varying weight ratios, relative to each other, such a

method wherein the concentration of water in the hydrogenation reaction medium is greater than 50%, such a

method wherein hydrogenation is facilitated by the addition of a supported palladium catalyst, such a

method wherein the palladium catalyst is in oxidic form, such a

method wherein hydrogenation is performed in a sealed reactor with a continuous supply of hydrogen gas at a pressure of 15-100 psig and at a temperature of 35-60° C., such a

method wherein the pressure of hydrogen is 50 psig, such a

method wherein the temperature is 35° C., such a

method wherein the heterogeneous catalyst is removed following the hydrogenation reaction via filtration and solvent alcohol is removed by vacuum distillation or any other form of desolventization know to those skilled in the art, such a

method wherein the alkaline solution used for pH adjustment is potassium hydroxide, such a

method wherein the recovery yield of starting hop extract humulones to the resulting tetrahydroisohumulones is greater than 70%, such a

method wherein the recovery purity of the resulting tetrahydroisohumulones is greater than 90%, such a

method wherein the resulting tetrahydroisohumulone composition is a suitable additive for bitter flavor in beer brewing processes, wherein

a purified tetrahydroisohumulone composition is obtained by the method.

A method of preparing a tetrahydroisohumulone composition, comprising the steps of:
a. adding a lower alcohol solvent to isohumulones and adjusting the pH to 7.5-11 with an alkaline solution;
b. adding 2-7% by dry mass, relative to the mass of isohumulones, of a supported noble metal hydrogenation catalyst to the alkaline aqueous/alcohol solution of isohumulones;
c. stirring the solution in the presence of 15-100 psig of hydrogen gas at a temperature of 35-60° C. for 1-6 hours;
d. releasing hydrogen pressure and recovering the reaction solution by removing the hydrogenation catalyst via filtration;
e. removing the alcohol solvent and concentrating the tetrahydroisohumulone solution through distillation; and
f. adjusting the pH and concentration of the tetrahydroisohumulone solution with an aqueous alkaline solution to a final pH of 9.0-11.0 and to a desired concentration while stirring.

A method of preparing purified isohumulones, comprising the steps of:
a. dissolving isohumulones prepared by the extant art in a water-immiscible solvent;
b. washing the organic solution with water, by adding water, stirring, and separating the phases;
c. optionally, repeating step (b) to further remove ionic or polar species;
d. recovering the organic phase and mixing it with 0.25-1 volume of water, warming the mixture to 30-45° C., adjusting the pH to 6.7-7.0 with an aqueous alkaline solution, with stirring, and then separating the phases; and
e. recovering, desolventizing, and concentrating the aqueous layer containing the purified isohumulones, such a

method wherein the water-immiscible solvent is a hydrocarbon solvent, such a

method wherein the hydrocarbon solvent is isohexanes, such a

method wherein the isohexane is a mixture of saturated hydrocarbons, predominantly of the formula C₆H₁₄, with a boiling point range of about 65 to 71° C., where the major isomers are n-hexane and 2-methylpentane, such a

method wherein the water-immiscible solvent is a mixture of hydrocarbons, such a

method wherein the water-immiscible solvent is a mixture of hydrocarbons, which are predominantly composed of six carbons and varying in their weight ratios, relative to each other, such a

method wherein said aqueous alkaline solution is selected from one or more of hydroxides of sodium or potassium, such a

method wherein the aqueous alkaline solution is potassium hydroxide, such a

method for preparing a purified tetrahydroisohumulone composition by utilizing an aqueous solution containing isohumulones which have been purified.

A method of preparing a tetrahydroisohumulone composition, comprising the steps of:
a. adding a lower alcohol solvent to isohumulones in their free acid form;
b. adding 2-7% by dry mass, relative to the mass of isohumulones, of a supported noble metal hydrogenation catalyst to the alcohol solution of isohumulones;
c. stirring the solution in the presence of 15-100 psig of hydrogen gas at a temperature of 35-60° C. for 1-7 hours;
d. releasing hydrogen pressure and recovering the reaction solution by removing the hydrogenation catalyst via filtration;
e. removing the alcohol solvent from the tetrahydroisohumulones through distillation; and
f. forming an aqueous solution of tetrahydroisohumulones in salt form by adding water to the recovered tetrahydroisohumulones, heating, and adding an aqueous alkaline solution to a final pH of 9.0-11.0 while stirring.

### BRIEF DESCRIPTION OF THE FIGURES

FIG. 1. Hydrogenation of Iso-α-acid to Tetrahydroiso-α-acid.

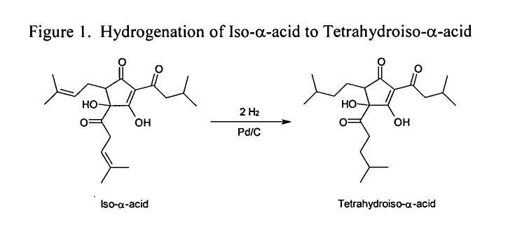

### DETAILED DESCRIPTION OF THE INVENTION

This invention relates to a practical and effective process of providing purified tetrahydroisohumulones from hop extract through isolation and isomerization of humulones and hydrogenation of the isohumulones, with minimal steps and handling. The process involves isolation and purification of humulones contained in hop extracts using a hydrocarbon solvent and alkaline aqueous partition, separating the aqueous layer and isomerizing humulones in the aqueous layer to isohumulones using a zinc or an alkaline earth metal salt isomerizing agent. Once isomerization is complete, the isohumulone-divalent metal complex formed is treated with acid and a hydrocarbon solvent to separate the purified isohumulones from the metal ions. The resulting isohumulones are further purified by extraction into an aqueous alkaline solution. The purified isohumulones are then reduced through hydrogenation with a supported transition metal catalyst to afford light-stable tetrahydroisohumulones.

The present invention provides an economical and effective process for isolating humulones in high purity from hop extract, isomerizing said humulones to isohumulones, recovering isohumulones in high purity, and transforming the isohumulones into tetrahydroisohumulones in high yields and purity that are suitable for use in the brewing of beer or other processes.

### Sources

Humulones, which consist of a number of congeners, including compounds commonly referred to as n-, co- and ad-derivatives as well as other minor constituents, are found in the female flower cones, also known as strobiles, of the hop plant (Humulus lupulus). Liquid hop extracts are commercial products which are well known in the art, and are produced by organic solvent extraction as well as supercritical or liquid carbon dioxide extraction of hop cones to remove beer bittering agents such as humulones and lupulones. The present invention shall not be limited to any particular type of hop extract, although extraction by means of low-pressure supercritical carbon dioxide processing is preferred due to high concentration of humulones and lower concentrations of undesirable plant by-products, in particular waxes, fats, and fatty acids. Low-pressure extracts (≦2400 psi) tend to be lower in triglyceride and fatty acid concentrations, generally <1.5% by mass calculated as free fatty acids (FFA), than extracts of higher pressures (˜3800-4500 psi), generally 2.5-6% FFA (Chrastil, 1982; Ribeiro and Bernardo-Gil, 1995; Garlapati and Madras, 2008). The pH and temperature encountered in the humulone isomerization process hydrolyze any glycerides present into free fatty acids and glycerol. The free fatty acids can be problematic in high concentrations and crash out of solution to form a haze in the final solution.

The solubility behavior of fatty acids in the final product varies based on the number of carbon atoms, pH, temperature, etc. Fatty acids typically contain anywhere from about eight to twenty-two carbon atoms. Examples of these fatty acids include linoleic, palmitic, oleic, linolenic, behenic, myristic, stearic, lauric, and the like. As the chain length increases the solubility of the fatty acids in water decreases (Reiger and Rhein, 1997).

### Isolating Humulones

Isolating humulones from hop extract prior to processing allows the remaining valuable hop chemicals, such as lupulones and hop oils, to be reserved for other purposes with minimal modifications of their chemical properties due to the temperature, pH and other processing conditions required in the isomerization process. Isolating humulones from extract prior to processing can be achieved due to the solubility characteristics of humulones compared to the other organic hop constituents, providing material in high yields and purities for isomerization starting material. Isolating humulones from extract in relatively high purities is important to remove a majority of lupulones and fatty acids, in particular fatty acids with greater than or equal to 16 carbons in chain length, that result in solid and haze formation in the final product due to their poor solubility.

To isolate humulones, the hop extract is dissolved in an equal volume of a hydrocarbon solvent such as isohexane. Isohexane is defined as a mixture of saturated hydrocarbons, predominantly of the formula C₆H₁₄, hereafter referred to as isohexane(s). This process can also be done without isohexane, but the use of isohexane helps to create a cleaner partition with higher yields of humulones in the aqueous partition and lower levels of lupulones and fatty acids (see Example 2), which will produce solids and haze formation in the final products if not removed (Foster, 1995). The solution is mixed with a 3% potassium hydroxide (KOH) aqueous solution, using about a 0.9-1.1 (including 1.1) molar equivalent of base to humulone, thereby increasing the solubility of the humulones and providing a pH of about 8.2 to 9.0. The mixture is stirred for 10 to 20 minutes at a temperature of about 35 to 45° C. KOH reacts with humulones (alpha acids) to form water soluble potassium salts of humulones that are easily partitioned away from the other constituents of the extract, which remain largely in the isohexane (or organic) layer.

After stirring, the organic phase and aqueous phase are separated. The humulone-enriched aqueous phase, which contains 70 to >98% of the starting humulones, depending on the molar equivalents of KOH used (see Example 2), is collected and the pH is adjusted to 8.9 to 9.2 by the addition of 10% potassium hydroxide in preparation for isomerization. It is important that the pH not exceed 9.5. High pH increases the rate of formation of degradation compounds, such as allo-isohumulones and humulinic acid, during isomerization, which lowers the purity of the final product and in the extreme causes a haze in the final product (Goldstein et al., 1988). The variables described in this step can be varied based on starting extract to contain a humulone-enriched aqueous partition with low levels of lupulones (including <0.5%) and fatty acids (including <0.1%) with optimal yield of humulones by those skilled in the art.

### Isomerizing Humulones

The humulone-enriched aqueous solution is mixed and heated to reflux under an atmosphere of nitrogen or other inert gas. Reflux temperatures help to ensure complete isomerization in a relatively short amount of time. Once the solution is at or below reflux, 0.1-1.0 molar equivalent of an aqueous solution (or powder form) of a divalent alkaline earth metal salt, relative to humulones, is added slowly to minimize solid formation. Exemplary alkaline earth metal salts suitable as isomerizing agents include but should not be limited to oxides, hydroxides, sulfates, chlorides, acetate or other carboxylates of Mg and Ca, where MgSO₄ is an excellent catalyst. Although it is not an alkaline earth metal ion, Zn(II), which is used by brewers to control yeast growth in the process of brewing, is also an effective isomerization catalyst, and in the discussion that follows, zinc should also be considered where alkaline earth metals are discussed. The fact that brewers already use zinc in the brewing process is seen as an advantage in using it in the isomerization of hop acids. Examples of Zn compounds include, but should not be limited to, the oxide, hydroxide, sulfate, chloride, and acetate or other carboxylates of Zn(II). The amount of isomerizing zinc or alkaline earth metal salt agent will impact the reaction time and the distribution of cis- and trans-isohumulones in the final product. The ratio of cis- to trans-isohumulones is about 1.4 under isomerization conditions without addition of an alkaline earth metal salt. In comparison, the ratio of cis- to trans-isohumulones varies from about 2.3 to 4.0 by addition of 0.1 to 1.0 molar equivalents, respectively, of magnesium sulfate, relative to the humulones, using the instant process. An amount of 0.4 molar equivalent of an aqueous solution of MgSO₄ relative to humulones provides a quick reaction time, low impact on reaction pH and, as mentioned previously, higher ratios of the more soluble and stable cis-isomers using the minimal amount of metal ions (see Example 3). A similar increase in the ratio of cis- to trans-isohumulones was observed when a zinc isomerization catalyst is used. The ratio of cis-isohumulones to trans-isohumulones in the product was calculated to be 3.5 for the zinc catalyst used in Example 6. The reaction mixture is heated at reflux under an atmosphere of an inert gas such as nitrogen for about 1.25 hours or until isomerization is complete. Reaction completion (>98% humulone isomerized to isohumulone) can be checked by using high pressure liquid chromatography (HPLC), ultraviolet (UV) spectroscopy, or any other method known to those skilled in the art. Once the reaction is complete the solution is cooled to 85° C.

### Removing Metal Ions

The isohumulone-enriched solution contains isohumulone chelates of metal ions that must be separated. Low pH is needed to release zinc and magnesium ions from the hop acid chelate. The metal ions need to be separated from the hop acids and removed; otherwise solids and haze formation in the final product will occur. In order to break the metal chelate that has formed, the reaction mixture is mixed with a solution of about 1.0 molar equivalents (relative to the isohumulones) of 35% sulfuric acid (H₂SO₄) and stirred at 85° C. for approximately 1 hour under an atmosphere of an inert gas. The amount of acid added can be optimized by those skilled in the art to effectively break the zinc or alkaline earth metal-isohumulone chelate based on the isomerizing metal salt agent and acid used. The chelates of zinc require more acid than do the magnesium chelates to effectively break the chelate and recover the isohumulones in good yield and purity (1.2 molar equivalents of sulfuric acid relative to isohumulones compared to 0.9 to 1.1 molar equivalents for magnesium chelates). The mixture is then cooled to 40° C. and an equal volume of a water-immiscible solvent such as isohexane is added. Isohexane is used to separate the acid-form of the isohumulones from the aqueous solution, which contains high magnesium, sulfate, and hydrogen ion concentrations. The amount of isohexane used can be varied, but 0.85 volumes, relative to the volume of the reaction mixture works well. The resulting solution is stirred and then the organic isohexane phase and aqueous phases are separated. The organic phase is recovered and washed by thoroughly mixing with about one third volume of water at 40° C. and separated to ensure thorough washing of the isohexane layer. This wash step can be optionally repeated with another aliquot of water. Reverse osmosis (RO-grade) water can be used throughout to help remove residual ionic species from the isohexane layer. Water-immiscible solvent can be subsequently removed via vacuum distillation. The resulting acidic isohumulone oil/resin concentrate is relatively free of metal salts (see Example 4).

### Purifying Isohumulones

The isohumulones can be further purified to remove residual lupulones and fatty acids that have been carried through the process. Lupulones and fatty acids are less soluble in water than the preferred isohumulones and are therefore removed to avoid the formation of precipitates and haze in the final product. The oxidation of unsaturated fatty acids, especially linoleic acid, can produce undesired flavors (cardboard flavor) due to the formation of (E)-2-nonenal (Vanderhaegen, 2006). To remove residual lupulones and fatty acids, water is added to the isohumulone-enriched organic layer prior to vacuum distillation, the mixture is heated to 40° C. with stirring, and the pH is adjusted to 6.7 to 7.0 with 10% KOH. Stirring is continued for about 20 minutes, and then the phases are separated. Slightly elevated temperatures help prevent the formation of gums during this process step and shorten pH stabilization time. The aqueous layer containing purified isohumulones is recovered, desolventized and concentrated. The purified isohumulone concentrate material (generally >90% purity) is relatively free of lupulones and fatty acids (see Example 5). In preparation for hydrogenation, the concentrate is diluted with water to a desired concentration while stirring and heating to 40-60° C., where warming ensures complete dissolution of isohumulones during this step of the process.

### Hydrogenation of Isohumulones

Isohumulones can be directly hydrogenated to afford light-stable tetrahydroisohumulones. The hydrogenation process, which reduces the carbon-carbon double bonds in the side chains of isohumulones, must proceed cleanly to provide the desired tetrahydroisoalpha acids in high yield and purity. Conditions that result in an incomplete hydrogenation will leave light-sensitive isoalpha acids and partially-hydrogenated dihydroisoalpha acids in the final product. Conversely, conditions that promote over-hydrogenation will afford neo-tetrahydroisoalpha acids, which do not impart bitterness to the beer and will thus impact overall yield. By employing the conditions described below, isohumulones can be cleanly and readily converted to tetrahydroisohumulones by a straightforward and simple to operate process. The method operates at relatively low temperatures and pressures and can tolerate high water content and low alcohol content solutions with a minimal amount of catalyst. Other than removal of the heterogeneous catalyst and alcohol solvent, the resulting aqueous solution of tetrahydroisoalpha acids requires no further purification or processing.

Isohumulones can be converted to tetrahydroisoalpha acids through hydrogenation with a supported noble metal catalyst. In order to generate the reaction mixture for hydrogenation, a lower alcohol is added to an isohumulone concentrate. The pH of the solution is then adjusted to 7.5-11 by addition of 10% KOH and dilution with RO-grade water prior to hydrogenation. The resulting solution contains approximately 23% isoalpha acids as their potassium salt, 24% alcohol, and 53% water. Stegink et al. (U.S. Pat. No. 5,296,637) showed that undesirable perhydrogenated byproducts can be avoided in the hydrogenation of humulones by hydrogenating these a-acids as alkaline metal salts in aqueous/alcohol solutions, where an elevated pH ensured that only very small amounts of the humulones were in their natural acidic form. This strategy is directly transferable to the hydrogenation of isoalpha acids in the present invention. Following pH adjustment, a supported palladium catalyst (5% Pd, 50% water) is added to the solution. The amount of catalyst added ranges from 4-14% by mass, as the wet solid, relative to the mass of isoalpha acids. Thus, the actual dry weight of palladium added is approximately 2-7% of the mass of the isohumulones. Compared to the extant art, this represents a significant decrease in the amount of catalyst necessary for the reaction to proceed. The unexpected ability to retain the catalytic activity of the solution with this lower catalyst loading is attributed to the purification of the humulones, and optionally the isohumulones, prior to hydrogenation, which is effective at removing species that poison the surface of the hydrogenation catalyst. After addition of the catalyst to the isohumulone solution, the mixture is transferred to a stirred reactor and the atmosphere above the solution is removed under vacuum. The vessel is pressurized to 15-100 psig with hydrogen gas and heated to 35-60° C. with stirring. The temperature and pressure are maintained throughout the hydrogenation, and the uptake of hydrogen by the reaction is monitored. At reaction completion essentially all of the isoalpha acids have been converted to tetrahydroisoalpha acids, which is marked by a sharp decline in the flow of hydrogen to the reactor and thus over-hydrogenation is prevented. In essence, the hydrogenation of isohumulones in their alkaline salt form is self-regulating under our conditions. Hydrogenation can take from 1 to 6 hours for completion. Following hydrogenation, the vessel is depressurized, the heterogeneous catalyst is removed by filtration from the reaction solution, and the alcohol solvent is removed from the reaction solution by warming under reduced pressure to afford an aqueous solution of pure tetrahydroisoalpha acids. Upon adjustment of solution concentration and pH, the product is suitable for use in the brewing or other industries.

The hydrogenation of isohumulones to tetrahydroisohumulones in the present invention is an improvement over the extant art. Purification of the humulones, and optionally the isohumulones, prior to the hydrogenation reaction affords an input material that requires lower amounts of expensive noble metal catalysts and obviates the need for extensive post-hydrogenation processing. Hydrogenation of isohumulones as their alkaline salt form provides a clean conversion that minimizes the formation of perhydrogenated byproducts. In addition, the use of an oxidic palladium on carbon catalyst, coupled with a pre-purified input, allows for the hydrogenation to be performed with less alcohol solvent and higher levels of water, greater than 50%, while still maintaining high catalytic activity. The result is unexpectedly high yields (>90%) of high purity (>90%) tetrahydroisoalpha acids, when compared to the extant art. The product from the present invention is a solution with high stability and only minor levels of oxidation byproducts, which greatly improves its performance in typical brewing applications.

### EXAMPLES

### Example 1

### Isolation of Humulones from CO₂ Hop Extract and Isomerization

Supercritical CO₂ hop extract (50.0 g), containing 51.4% humulones, was mixed with 1 volume of isohexane by overhead stirring in a 500-mL round bottom flask (RBF) until the extract dissolved. Aqueous 3% KOH solution (150. g) was added to the mixture to provide approximately 1.1 molar equivalents of KOH to humulones. The mixture was stirred for 20 minutes at 40° C., transferred to a 500-mL separatory funnel and allowed to separate for 30 minutes. The lower aqueous phase was collected and analyzed (results in Table 1 “Humulone Isolation” step). The pH of the humulone-enriched aqueous phase was adjusted from 8.6 to 9.0 with an aqueous 10% KOH solution and heated to reflux (˜104° C.) in a 500-mL RBF under an atmosphere of nitrogen. Once the solution approached reflux, 0.4 molar equivalents (relative to humulone) of an aqueous MgSO₄ solution (7.12 g MgSO₄ heptahydrate in 21 mL RO-grade water) was added slowly to the reaction flask. The reaction was stirred for 1.25 hours at reflux and then analyzed by HPLC to show that >99% of the humulones were isomerized to isohumulones (see step “Post-Isomerization” in Table 1). The reaction was cooled to 85° C. and mixed with 20.23 g of 35% H₂SO₄, which is 1.0 molar equivalent H₂SO₄ relative to isohumulones. The resulting mixture was stirred for one hour. The solution was cooled to 40° C., mixed with one volume isohexane for 20 minutes, and transferred to a 500-mL separatory funnel. The organic phase was recovered, mixed with one-third volume of water at 40° C., and separated to ensure thorough washing of the isohexane layer. Reverse osmosis (RO-grade) water was used to remove residual ionic species from the isohexane layer. The resulting acidic isohumulone isohexane layer was relatively free of metal salts (see step “Acid/Water Wash” in Table 1). An optional second wash can be performed if the metal salt level is too high at this point. The isohexane layer was further purified by mixing it with one third the volume of RO-grade water at 40° C. and adjusting the pH to 7.0 with 10% KOH in a RBF. The solution was transferred to a separatory funnel and allowed to separate. The lower aqueous layer was collected, desolventized by rotary evaporation to remove residual solvents, and analyzed (see “Purified Material” step in Table 1).

TABLE 1
Experimental Results for Example 1.

| | Mass | Humulone | Lupulone | Isohumulone | Fatty Acids | Residual | % Yield Isohumulone from |
|---|---|---|---|---|---|---|---|
| Step | (g) | (%) | (%) | (%) | (%) | Mg⁺² (mg/kg) | humulone in extract |
| Starting Extract | 50.03 | 51.40 | 13.80 | 0.00 | 0.88 | 0.00 | 0.00 |
| Humulone Isolation | 177.45 | 14.32 | 0.44 | 0.00 | 0.13 | 0.00 | 0.00 |
| Post-Isomerization | 176.49 | 0.03 | 0.47 | 14.17 | 0.09 | 2870.00 | 97.25 |
| Acid/Water Washed | 50.35 | 0.01 | 0.25 | 49.33 | 0.11 | <10 | 96.58 |
| Purified Material | 37.27 | 0.00 | 0.00 | 64.32 | 0.03 | <10 | 93.21 |

The resulting isohumulone concentrate was diluted with water and adjusted to a pH of 9.2 with 10% KOH to a concentration of 30% isohumulones. The final solution contained isohumulones with HPLC purity of 94.36%, based on peak areas, and yielded 93.21% of the extract's original humulones as isohumulones and was moreover described to be essentially free from undesirable lupulones, residual humulones and fatty acids.

### Example 2

### Evaluation of Humulone Isolation Conditions from CO₂ Hop Extract

The amount of humulones extracted from the hop extract was dependent on the molar equivalents of KOH added. Isohexane was added to dissolve the extract, assist in partitioning, and provide a cleaner cut of aqueous humulone to isomerize with minimal change to the valuable chemicals remaining in the hop extract, such as lupulones and hop oils. The humulones were separated from the hop extract by dissolving the hop extract with one volume of isohexane. The solution was mixed with a 3% KOH aqueous solution at 0.9-1.1 molar equivalent to humulone, which provided a pH of approximately 8.2-9.0. The solution was mixed for 10-20 minutes at 35-45° C. After stirring, the organic layer and humulone-enriched aqueous layers were separated. The separation step can be varied to obtain the highest yield of humulones with minimal lupulone and fatty acid concentrations based on the extract being used. A series of separations were performed on hop extract obtained by means of low-pressure supercritical carbon dioxide extraction to show yield differences using KOH molar equivalents of 0.9, 1.0, 1.1 (all with isohexane) and 1.1 without isohexane. The results for the humulone-enriched aqueous layers are shown in Table 2.

TABLE 2
Experimental Results for Example 2.

| | KOH Equivalents | Isohexane/ | Humulone | Lupulone | Isolated Yield of | % Fatty |
|---|---|---|---|---|---|---|
| ID | (mol) | Solventless | (%) | (%) | Humulone (%) | Acids |
| 1 | 1.1 | isohexane | 14.2 | 0.29 | 98.2 | 0.04 |
| 2 | 1.1 | solventless | 13.5 | 0.61 | 91.7 | 0.19 |
| 3 | 1.0 | isohexane | 14.0 | 0.17 | 87.0 | 0.07 |
| 4 | 0.9 | isohexane | 13.0 | 0.10 | 72.0 | 0.01 |

The separation that produced the highest yield of humulones with minimal lupulones and fatty acids was sample ID #1, which yielded >98% of the humulones from the starting extract. After separation, the humulone-enriched aqueous layer was adjusted to a pH of 8.9-9.2 with 10% KOH in preparation of isomerization. This pH range enhanced the rate of the reaction while remaining below the higher pH settings that promoted humulone degradation.

### Example 3

### Impact of the Amount of Mg(II) Ion on the Isomerization Process

The amount of isomerizing alkaline earth metal salt agent can impact reaction time and cis/trans-isomer levels of isohumulones. A series of reactions were performed using optimal aqueous humulone-enriched material from Example 2 to show the effects of various molar equivalents of MgSO₄ on the resulting isohumulone product. Results of these experiments are shown in Table 3.

TABLE 3
Experimental results for Example 3.

| | | | Result after Isomerization | |
|---|---|---|---|---|
| | Mg Equivalents | Reaction | Residual | Cis/Trans |
| ID | (mol) | Time (hours) | % Humulone | Isomer Ratio |
| 1 | 0.1 | 5.25 | 0.65 | 2.32 |
| 2 | 0.2 | 1.5 | 0.39 | 3.02 |
| 3 | 0.3 | 1 | 0.05 | 3.43 |
| 4 | 0.4 | 0.75 | 0.08 | 3.83 |
| 5 | 0.5 | 0.25 | 0.09 | 3.88 |
| 6 | 1.0 | <0.25 | 0.04 | 3.94 |

It is important to minimize the amount of metal compositions being used so they can be effectively removed later in the process. The amount of MgSO₄ used in this process was, but is not limited to, 0.4 molar equivalents relative to the amount of humulones in the reaction mixture. After reaction completion, the reaction was cooled to 85° C. Reaction completion (>98% humulone isomerized to isohumulone) can be checked by high pressure liquid chromatography (HPLC), ultraviolet (UV) spectroscopy or any other method known to those skilled in the art.

### Example 4

### Impact of the Amount of Acid on Mg(II) Ion Removal

Magnesium ions need to be separated from the hop acids and removed otherwise solids and haze formation in the final product will occur. To break the magnesium isohumulone chelate, an aqueous 35% sulfuric acid (H₂SO₄) solution was added to provide 1.0 molar equivalent (relative to isohumulone), stirred by vigorous overhead stirring mechanism and heated at 85° C. for 1 hour under an atmosphere of nitrogen. After one hour the mixture was cooled to 40° C. and an equal volume of isohexane was added. The solution was stirred for approximately 15 minutes and then allowed to separate. The organic phase was recovered and mixed with one third volume of water at 40° C. for 15 minutes and again separated to ensure a thorough washing of the isohexane layer. Reverse osmosis (RO-grade) water was used for this wash to remove residual ionic species from the isohexane layer. An additional water wash can be performed, if needed, to remove residual ionic species. The resulting acidic isohumulone concentrate was relatively free of metal salts. A series of experiments were preformed to show the effects of various molar equivalents of H₂SO₄ to isohumulone using material made with the most optimal conditions from Example 3.

TABLE 4
Experimental Results for Example 4.

| | H₂SO₄ Equivalents | Resulting | Residual Mg⁺² | Isohumulone |
|---|---|---|---|---|
| ID | (mol) | pH | ions (mg/kg) | Retained (%) |
| Start | 0.0 | — | 2870.0 | — |
| 1 | 0.5 | 2.98 | 456.0 | 78.9 |
| 2 | 0.7 | 2.45 | 71.0 | 94.2 |
| 3 | 0.9 | 2.16 | <10 | 99.9 |
| 4 | 1.0 | 1.74 | <10 | 100.0 |
| 5 | 1.1 | 1.40 | <10 | 99.9 |

A 1.0 molar equivalent of H₂SO₄ to isohumulone is used to ensure complete disassociation of magnesium and isohumulone. The acidic isohumulone concentrates were mixed with one third the volume of water at 40° C. in preparation for the further purification of the isohumulones as described in Example 5.

### Example 5

### Impact of Purification pH on Isohumulone Yield and Purity

The acidic form of isohumulones prepared by the process in Example 4 can be further purified to remove residual lupulones and fatty acids that have been carried through the process. Lupulones and fatty acids are less soluble than the preferred isohumulones and can therefore be removed to avoid appearing as precipitate and haze in the final product. A majority of the lupulones was removed in the humulone isolation step (Example 2), and the residual lupulones should be easily partitioned away at a pH<9.0. To remove residual fatty acids from the isohumulones, the mixture was stirred at 40° C. and the pH was adjusted to 6.7 to 7.0 with 10% KOH. The mixture was stirred for 20 minutes and then the phases were allowed to separate in a separatory funnel. The aqueous layer solubilized the isohumulones while leaving the residual lupulones and a majority of the fatty acids in the isohexane layer. The aqueous isohumulone-enriched layer was collected, desolventized and concentrated to remove residual levels of isohexane. A series of experiments were performed to demonstrate various levels of pH and their effectiveness in removing residual lupulones and fatty acids from the isohumulone product (see Table 5).

TABLE 5
Experimental Results for Example 5.

| | | Residual | % Yield Isohumulone from | % Fatty acids in 30% | HPLC % Purity of | |
|---|---|---|---|---|---|---|
| ID | pH | % beta | humulone in starting extract | isohumulone product | Isohumulone | Cold Test |
| 1 | 5.50 | <0.05 | 50.27 | 0.00 | 89.33 | Clear |
| 2 | 6.10 | <0.05 | 89.42 | 0.01 | 90.86 | Clear |
| 3 | 6.30 | <0.05 | 92.04 | 0.01 | 90.84 | Clear |
| 4 | 6.50 | <0.05 | 93.61 | 0.02 | 91.91 | Clear |
| 5 | 6.70 | <0.05 | 93.61 | 0.02 | 91.73 | Clear |
| 6 | 7.00 | <0.05 | 96.17 | 0.02 | 91.93 | Clear |
| 7 | 7.30 | <0.05 | 93.96 | 0.05 | 91.76 | Clear |
| 8 | 7.60 | <0.05 | 94.72 | 0.07 | 91.52 | Clear |
| 9 | 8.00 | <0.05 | 90.70 | 0.11 | 90.6 | Slight Haze |
| 10 | 8.50 | <0.05 | 90.12 | 0.24 | 90.11 | Haze |
| 11 | 9.00 | <0.05 | 89.65 | 0.65 | 89.81 | Haze |
| 12 | 9.50 | 0.33 | 89.42 | 1.10 | 88.12 | Haze |

The purified concentrate was desolventized to remove residual solvents, diluted with water to the desired concentration, and the solution pH was adjusted to 9.0 to 10.0 with aqueous KOH to 40°-60° C. Warming ensured complete dissolution of isohumulones. Each of the samples made above were subjected to a cold test by placing approximately 20 mL of product in a freezer at 0° C. for 24 hours. After 24 hours the samples were visually observed for clarity. The isohumulone compositions with minimal impurities remained clear while isohumulone solutions with more impurities (in particular >0.1% fatty acids) showed a few particulates or many that produced a haze after 24 hours. Results for the cold test are also shown in Table 5.

### Example 6

### Use of Zn(II) as an Isomerization Agent

A 3-neck 500-mL round bottom flask equipped with a magnetic stir bar was charged with an aqueous solution of humulones (230 g, 14.2% humulones, Example 2—ID No. 1). The pH was adjusted from 8.7 to 9.0 with a small amount of 10% KOH, and the solution was warmed to reflux under an atmosphere of purified nitrogen gas. After the solution approached reflux, a solution of Zn(II) ions, which was prepared by dissolving 8.2 g of zinc acetate dihydrate in 50 mL of RO-grade water, was slowly added under a positive flow of nitrogen to provide a 0.4 molar equivalent of zinc ions relative to humulones. The mixture was heated at reflux under nitrogen for 1.7 hours and then cooled to ambient temperature, which resulted in the precipitation of a solid containing a chelate of zinc and isohumulones. After decanting the liquid phase from the solid, 35% sulfuric acid solution (32 g, 1.2 molar equivalents) was added to the solid. Heating to 92° C. with stirring afforded an orange oil in which the zinc-isohumulone chelate had been broken. Isohexane (300 mL) was added to the previously decanted liquid, and to this was added the warm acidic mixture of isohumulones with rapid stirring. The resulting isohumulone-enriched isohexane layer was then separated from the aqueous salt solution. Residual ions were removed from the isohexane layer by washing with RO-grade water (2×100 mL). Water (80 mL, RO-grade) was added to the isohexane layer containing the isohumulones and the mixture was warmed to 40° C. Potassium hydroxide solution (10%) was slowly added with stirring to raise the solution pH from 2.7 to a value of 6.9. The lower aqueous layer, which contained the isohumulones, was separated from the isohexane layer containing residual non-isomerized humulones, lupulones, and fatty acids. Rotary evaporation was used to desolventize and concentrate the aqueous isohumulone solution. The final solution contained 23 g of isohumulones (71% yield from humulones) with an HPLC purity of 93%. The ratio of cis-isohumulones to trans-isohumulones in the product was calculated to be 3.5 based on HPLC peak areas, which is consistent with the ratio observed when alkaline earth metal salts are used as isomerizing agents. The step of separating the zinc-isohumulone chelate from the reaction solution was performed due to the stronger chelation of the isomerized hop acid with this metal ion relative to magnesium and the need to break this chelate to prevent metal contamination in an isohumulone composition.

### Example 7

### Hydrogenation of Purified Isohumulones in Potassium Salt Form in an Aqueous/Alcohol Solution

A 250-mL beaker was charged with an aqueous solution of purified isohumulones, generated as in Example 1, containing 30.2% isoalpha acids by HPLC analysis (89.6 g solution, 27.1 g isoalpha acids) that had been adjusted to a pH of 9.5 with 10% KOH. Methanol was added to bring the total solution volume to 125 mL. An oxidic palladium on carbon catalyst (2.16 g, 5% Pd, ca. 50% H₂O) was added to the solution, and the mixture was transferred to a 600-mL stirred reactor (Parr Model 4568 made of Carpenter Steel 20CB3). After evacuating the atmosphere above the solution under vacuum, the reactor was charged with hydrogen gas to a pressure of 50 psig, and the solution was warmed to 35° C. with stirring. The temperature and pressure were maintained for 2 hours at which time the low rate of hydrogen uptake suggested reaction completion. The reactor was cooled and depressurized, and and the reaction solution was recovered by removing the hydrogenation catalyst via filtration. Solvent was removed from the reaction solution via rotary evaporation to afford a solution containing tetrahydroisohumulones with a yield of 94.2%, relative to the input of isohumulones, and a purity of 95% (based on HPLC peak area analysis).

### Example 8

### Hydrogenation of Purified Isohumulones in Salt Form in an Aqueous/Alcohol Solution

A 250-mL beaker was charged with an aqueous solution of purified isohumulones, generated as in Example 1, containing 29.9% isoalpha acids by HPLC analysis (90.0 g solution, 26.9 g isoalpha acids, 95.6% purity based on HPLC peak areas). Ethanol (denatured with methanol) was added to bring the total solution volume to 125 mL. The pH of the solution was subsequently adjusted with a 10% KOH solution to a value of 7.5. An oxidic palladium on carbon catalyst (2.97 g, 5% Pd, ca. 50% H₂O) was added to the solution, and the mixture was transferred to a 600-mL stirred reactor (Parr Model 4568 made of Carpenter Steel 20CB3). After evacuating the atmosphere above the solution under vacuum, the reactor was charged with hydrogen gas to a pressure of 50 psig, and the solution was warmed to 35° C. with stirring. The temperature and pressure were maintained for 2.5 hours at which time the low rate of hydrogen uptake (<0.5 mL/min) suggested reaction completion. The reactor was cooled and depressurized, and the reaction solution was recovered by removing the hydrogenation catalyst via filtration. Solvent was removed from the reaction solution via rotary evaporation to afford a solution containing tetrahydroisohumulones with a yield of 95.1%, relative to the input of isohumulones, and a purity of 95.4% (based on HPLC peak area analysis). The resulting tetrahydroisohumulone concentrate was diluted with water and adjusted to a pH of 10.5 with 10% KOH to a concentration of 10.2% tetrahydroisohumulones. The final solution contained tetrahydroisohumulones with HPLC purity of 94.5%, based on peak areas.

### Example 9

### Hydrogenation of Isohumulones Prepared by the Extant Art

To an aqueous solution of commercially available isohumulones, containing 30% isoalpha acids by HPLC analysis (90.4 g solution, 27.1 g isoalpha acids) with a pH of 9.2, was added methanol (70 mL). An oxidic palladium on carbon catalyst (3.78 g, 5% Pd, ca. 50% H₂O) was added to the solution, and the mixture was transferred to a 600-mL stirred reactor (Parr Model 4568 made of Carpenter Steel 20CB3). After evacuating the atmosphere above the solution under vacuum, the reactor was charged with hydrogen gas to a pressure of 50 psig, and the solution was warmed to 35° C. with stirring. The temperature and pressure were maintained for 2.8 hours at which time the uptake of hydrogen by the reaction had dropped to <0.5 mL/min. The reactor was cooled and depressurized, and the reaction solution was recovered by removing the hydrogenation catalyst via filtration. Solvents were removed from the reaction solution via rotary evaporation to afford a viscous substance containing approximately 60% tetrahydroisohumulones by mass with a yield of 81%, relative to the input of isohumulones, and a purity of 92% (based on HPLC peak area analysis).

### Example 10

### Purification of Isohumulones and Hydrogenation

A 600-mL beaker was charged with commercially available isohumulones in their free acid form (106 g, 86.1% isohumulones based on HPLC), containing low but measureable levels of fatty acids, lupulones, and non-isomerized humulones. Isohexane (150 mL) and RO-grade water (100 mL) were added, and the mixture was stirred for 5 minutes. The layers were allowed to separate, and the isohumulone-enriched isohexane layer was recovered. RO-grade water (100 mL) was added to the hexane solution, and the mixture was stirred for 5 minutes. The layers were allowed to separate, and the isohexane layer was recovered. RO-grade water (80 mL) was added to the isohexane solution and the mixture was warmed to 40° C. with stirring. Potassium hydroxide solution (10%, 158.5 g) was then added slowly to raise the pH of the mixture to a value of 7.1. After allowing the layers to separate in the absence of stirring, the lower isohumulone-enriched aqueous layer was separated from the upper hexane layer containing non-isomerized humulones, lupulones, and fatty acids. Residual organic solvent was removed from the aqueous isohumulone layer, and the solution was concentrated via rotary evaporation to afford an aqueous isohumulone solution (282 g, 32.1% isohumulone concentration, 95% purity based on HPLC peak area analysis). Thus, over 99% of the input isohumulones were recovered in the purified aqueous solution.

A 250-mL beaker was charged with a portion of the aqueous solution of the purified isohumulones (84.4 g solution, 27.1 g isoalpha acids). The pH of the solution was adjusted with a 10% KOH solution to a value of 9.5, and RO-grade water (4.1 g) was added. Ethanol (30 g, denatured with methanol) was added, and the pH of the solution was verified at a value of 9.0. An oxidic palladium on carbon catalyst (2.7 g, 5% Pd, ca. 50% H₂O) was added to the solution, and the mixture was transferred to a 600-mL stirred reactor (Parr Model 4568 made of Carpenter Steel 20CB3). After evacuating the atmosphere above the solution under vacuum, the reactor was charged with hydrogen gas to a pressure of 50 psig, and the solution was warmed to 35° C. with stirring. The temperature and pressure were maintained for 3.5 hours at which time the low rate of hydrogen uptake suggested reaction completion. The reactor was cooled and depressurized, and the catalyst was removed from the reaction solution by filtration. The reaction solution was recovered and solvent was removed from the reaction solution via rotary evaporation to afford a solution containing 38.4% tetrahydroisohumulones with a yield of 90.1%, relative to the input of isohumulones, and a purity of 93.4% (based on HPLC peak area analysis).

### Example 11

### Hydrogenation of Unpurified Isohumulones in Potassium Salt Form in an Aqueous/Alcohol Solution

A 250-mL beaker was charged with unpurified acid-form isohumulones, generated from the Mg-catalyzed isomerization of humulones as described above but without the purification step as detailed in Example 5, containing 85.7% isoalpha acids by HPLC analysis (31.5 g, 27.0 g isoalpha acids, 95.9% purity based on HPLC peak areas). Potassium hydroxide (10% solution) was added to generate the potassium salt form of isohumulones and to adjust the solution pH to a value of 8.0. Water was added to bring the aqueous solution mass to 90.0 g (30% unpurified isohumulone solution), and ethanol (denatured with methanol) was added to bring the total solution volume to 125 mL. The pH of the solution was subsequently adjusted with a 10% KOH solution to a value of 7.5. An oxidic palladium on carbon catalyst (2.97 g, 5% Pd, ca. 50% H₂O) was added to the solution, and the mixture was transferred to a 600-mL stirred reactor (Parr Model 4568 made of Carpenter Steel 20CB3). After evacuating the atmosphere above the solution under vacuum, the reactor was charged with hydrogen gas to a pressure of 50 psig, and the solution was warmed to 35° C. with stirring. The temperature and pressure were maintained for 1.7 hours at which time the low rate of hydrogen uptake suggested reaction completion. The reactor was cooled and depressurized, and the reaction solution was recovered by removing the hydrogenation catalyst by filtration. Solvent was removed from the reaction solution via rotary evaporation to afford a solution containing tetrahydroisohumulones with a yield of 94.2%, relative to the input of isohumulones, and a purity of 95.0% (based on HPLC peak area analysis).

### Example 12

### Hydrogenation of Isohumulones in Acid Form

To isohumulones in their free acid form (27.5 g, 84% isohumulones by HPLC), generated from the Mg-catalyzed isomerization of humulones as described above, was added ethanol to afford a total solution volume of 125 mL. A palladium on carbon catalyst (1.38 g, 5% Pd, ca. 50% H₂O) was added to the solution, and the mixture was transferred to a 600-mL stirred reactor (Parr Model 4568 made of Carpenter Steel 20CB3). After evacuating the atmosphere above the solution under vacuum, the reactor was charged with hydrogen gas to a pressure of 50 psig, and the solution was warmed to 35° C. with stirring. The temperature and pressure were maintained for 6.3 hours at which time the total amount of hydrogen uptake suggested reaction completion. The reactor was cooled and depressurized, and the catalyst was removed from the reaction solution by filtration. Solvent ethanol was removed from the reaction solution via rotary evaporation to afford a solution of acid-form tetrahydroisohumulones in a yield of 82.5%, relative to the input of isohumulones, and a purity of 93.4% (based on HPLC peak area analysis).

### REFERENCES

1. Chicoye, Etzer; Fly, Walter H.; Goldstein, Henry, U.S. Pat. No. 4,759,941, Published Jul. 26, 1988.
2. Foster, Robert T., U.S. Pat. No. 5,478,580, Published Dec. 26, 1995.
3. Goldstein, Henry; Ting, Patrick L.; Chicove, Etzer; Goetzke, Gary; Cowles, John M., U.S. Pat. No. 4,767,640, Published Aug. 30, 1988.
4. Hay, Bruce A., U.S. Pat. No. 5,013,571, Published May 7, 1991.
5. Klüsters, Paul, U.S. Pat. No. 4,758,445, Published Jul. 19, 1988.
6. Koller, Horst; Hartl, Alfons E.; Kirchner, Gerhard, U.S. Pat. No. 3,952,061, Published Apr. 20, 1976.
7. Laws, Derek R. J., U.S. Pat. No. 4,780,330, Published Oct. 25, 1988.
8. Maye, John Paul; Xu, Jianping; Gauthier, George; Weis, Scott W., U.S. Pat. No. 6,198,004 B1, Published Mar. 6, 2001.
9. Paul, Herbert, U.S. Pat. No. 5,155,276, Published Oct. 13, 1992.
10. Poyner, William R.; Smith, Geoffrey; Westwood, Keith T.; Hysert, David W., U.S. Pat. No. 5,600,012, Published Feb. 4, 1997.
11. Smith, Robert J.; Wilson, Richard J. H., U.S. Pat. No. 5,370,897, Published Dec. 6, 1994.
12. Stegink, Larry J.; Guzinski, James A.; Todd, Paul H., Jr., U.S. Pat. No. 5,296,637, Published Mar. 22, 1994.
13. Ting, Patrick L.; Goldstein, Henry, U.S. Pat. No. 5,523,489, Published Jun. 4, 1996.
14. Ting, Patrick L.; VanSanford, Michael A.; Refling, Jay R.; Goldstein, Henry, U.S. Pat. No. 5,767,319, Published Jun. 16, 1998.
15. Ting, Patrick L.; Goldstein, Henry, U.S. Pat. No. 5,874,633, Published Feb. 23, 1999.
16. Ting, Patrick L.; Refling, Jay R.; Goldstein, Henry, U.S. Pat. No. 6,020,019, Published Feb. 1, 2000.
17. Ting, Patrick L.; Hoppe, Steven M.; Navarro, Alfonso; Goldstein, Henry; Ryder, David S., U.S. Pat. No. 6,303,824 B1, Published Oct. 16, 2001.
18. Todd, Paul H., Jr., U.S. Pat. No. 4,666,731, Published May 19, 1987.
19. Westwood, Keith T.; Crescenzi, Allan, U.S. Pat. No. 5,015,491, Published May 14, 1991.
20. Wilson, Richard J. H.; Smith, Robert J., U.S. Pat. No. 7,344,746 B1, Published Mar. 18, 2008.
21. Worden, Leonard R.; Todd, Paul H., Jr., U.S. Pat. No. 3,552,975, Published Jan. 5, 1971.
22. Brown, P. M.; Howard, G. A.; Tatchell, A. R., “Chemistry of Hop Constituents. Part XIII. The Hydrogenation of Isohumulone”, J. Chem. Soc. 1959, 545-551.
23. Chrastil, J., “Solubility of Solids and Liquids in Supercritical Gases” J. Phys. Chem., 1982, 86, 3016-3021.
24. Garlapati, C. and Madras, G., “Solubilities of Hexadecanoic and Octadecanoic Acids in Supercritical CO₂ With and Without Cosolvents” J. Chem. Eng. Data 2008, 53, 2913-2917.
25. Hay, B. A.; Homiski, J. W., “Efficient One-Step Preparation of the Beer Additive Tetrahydroiso-α-acids”, J. Agric. Food Chem. 1991, 39, 1732-1734.
26. Moir, M., “Hops—A Millennium Review”, J. Am. Soc. Brew. Chem. 2000, 58(4), 131-146.
27. Ribeiro, M. A. and Bernardo-Gil, M. G., “Solubilities of Triolein in Supercritical CO₂” J. Chem. Eng. Data 1995, 40, 1188-1192.
28. Rieger, Martin M. and Rhein, Linda D., Eds., “Surfactants in Cosmetics”, 2^{nd} Edition, Revised and Expanded (Surfactant Science Series, Vol. 68); Marcel Dekker: New York, 1997, 8.
29. Vanderhaegen, Bart; Neven, Hedwig; Verachtert, Hubert; Derdelinchx, Guy, “The chemistry of beer aging—a critical review” Food Chemistry 2006, 95, 357-381.
30. Verzele et al., “Sur La Transformation De L'Humulone” Cong. Internat. Indust. Ferm. 1947, 297-301.
31. Verzele, M., “Centenary Review—100 Years of Hop Chemistry and Its Relevance to Brewing”, J. Inst. Brew. 1986, 92, 32-48.
32. Verzele, M.; Keukeleire, D., Chemistry and Analysis of Hop and Beer Bitter Acids, Elsevier, New York, 1991; pp. 141-179.

1. A method for preparing a purified tetrahydroisohumulone composition, comprising the steps of:
a. dissolving a hop extract comprising humulones in a water-immiscible solvent and mixing in 0.7-1.1 molar equivalents, relative to humulone concentration, of an aqueous alkaline solution at a temperature of 35-45° C. to form a two phase separation;
b. recovering a humulone-enriched aqueous layer, and optionally, adjusting the pH to 8.6-9.0 with an aqueous alkaline solution;
c. heating the humulone-enriched aqueous layer under an inert atmosphere and adding a divalent metal compound isomerization catalyst at or before solution reflux;
d. maintaining the humulone enriched aqueous layer at or below reflux temperature under an inert atmosphere until isomerization of humulones to isohumulones is complete;
e. cooling the humulone enriched aqueous layer to 60-90° C.;
f. adding 0.9-1.2 molar equivalents, relative to isohumulones, of an aqueous solution of an acid at 60-90° C. for 0.5-2.0 hours under an inert atmosphere;
g. cooling resulting mixture to 30-45° C. and adding a water-immiscible organic solvent;
h. stirring, and then separating the organic and aqueous phases;
i. recovering the organic phase, and washing with water by adding water, stirring, and separating the phases;
j. optionally, repeating step (i) to remove ionic species;
k. recovering the organic phase and mixing it with 0.25-1.0 volume of water, warming the mixture to 30-45° C., adjusting the pH to 6.7-7.0 with an alkaline solution, with stirring, and then separating the phases;
l. recovering, desolventizing, and concentrating the aqueous layer comprising purified isohumulones;
m. adding a lower alcohol solvent to the aqueous layer containing purified isohumulones, wherein the concentration of water in the reaction medium is greater than 50%, and adjusting the pH to 7.5-11 with an alkaline solution;
n. adding 2-7% by dry mass, relative to the mass of isohumulones, of a supported noble metal hydrogenation catalyst to the isohumulone solution from step (m);
o. stirring the solution in the presence of 15-100 psig of hydrogen gas at a temperature of 35-60° C. for 1-6 hours;
p. releasing hydrogen pressure and recovering the reaction solution by removing the hydrogenation catalyst via filtration;
q. removing the alcohol solvent from the reaction solution and concentrating the solution comprising tetrahydroisohumulones through distillation; and
r. adjusting the pH and concentration of the tetrahydroisohumulone solution with an aqueous alkaline solution to a final pH of 9.0-11.0 and to a desired concentration while stirring.

2. The method of claim 1, wherein the hop extract is from cones of hop plants of the genus Humulus.

3. The method of claim 2, wherein the hop cones are extracted by means of solvent extraction, supercritical fluid extraction or other extraction means which are known to those skilled in the art.

4. The method of claim 1, wherein the water-immiscible solvent is a hydrocarbon solvent.

5. The method of claim 4, wherein the hydrocarbon solvent is isohexane.

6. The method of claim 5, wherein the isohexane is a mixture of saturated hydrocarbons, predominantly of the formula C₆H₁₄, with a boiling point range of about 65 to 71° C., wherein major isomers of the saturated hydrocarbons are n-hexane and 2-methylpentane.

7. The method of claim 1, wherein the water-immiscible solvent is a mixture of hydrocarbons.

8. The method of claim 7, wherein the hydrocarbons are predominantly composed of six carbons and varying in their weight ratios relative to each other.

9. The method of claim 1, wherein the aqueous alkaline solution is selected from one or more of hydroxides of sodium or potassium.

10. The method of claim 1, wherein the aqueous alkaline solution is potassium hydroxide.

11. The method of claim 1, wherein the divalent metal isomerization catalyst is selected from oxides, hydroxides, sulfates, chlorides, acetates and other carboxylates of Magnesium, Calcium, and Barium, and combinations thereof.

12. The method of claim 1, wherein the divalent metal isomerization catalyst is selected from zinc oxide, zinc hydroxide, zinc sulfate, zinc chloride, zinc acetate or other carboxylate, and combinations thereof.

13. The method of claim 11, wherein the divalent metal isomerization catalyst is MgSO₄ or any of its hydrated forms.

14. The method of claim 1, wherein the isomerization agent is a magnesium compound, and wherein the aqueous solution of an acid in step (f) is added in a range of 0.9-1.1 molar equivalents to relative to isohumulones at 60-90° C. for 0.5-2.0 hours under an inert atmosphere.

15. The method of claim 14, wherein the acid is selected from HCl, H₃PO₄ and H₂SO₄.

16. The method of claim 15, wherein the acid is H₂SO₄.

17. The method of claim 1, wherein the desolventizing is selected from vacuum drying and other forms of desolventizing known to those skilled in the art, which desolventizing achieves levels of solvent in a solution suitable for human consumption.

18. The method of claim 1, wherein the isohumulones are hydrogenated as an alkaline solution of isohumulate salts.

19. The method of claim 18, wherein the isohumulate is a potassium salt.

20. The method of claim 1, wherein the lower alcohol is methanol or ethanol.

21. The method of claim 20, wherein the lower alcohol is methanol.

22. The method of claim 20, wherein the lower alcohol is ethanol.

23. The method of claim 1, wherein the lower alcohol solution is a mixture of lower alcohols.

24. The method of claim 23, wherein the mixture of lower alcohols comprises ethanol, methanol, and/or isopropanol, with varying weight ratios relative to each other.

25. The method of claim 24, wherein the noble metal hydrogenation catalyst is palladium.

26. The method of claim 25, wherein the palladium catalyst is in oxidic form.

27. The method of claim 1, wherein hydrogenation is performed in a sealed reactor with a continuous supply of hydrogen gas at a pressure of 15-100 psig and at a temperature of 35-60° C.

28. The method of claim 27, wherein the hydrogen gas is at a pressure of 50 psig.

29. The method of claim 27, wherein the temperature is 35° C.

30. The method of claim 1, wherein the alkaline solution used for pH adjustment is potassium hydroxide.

31. The method of claim 1, wherein the recovery yield of starting hop extract humulones to the resulting tetrahydroisohumulones is greater than 70%.

32. The method of claim 1, wherein the recovery purity of the resulting tetrahydroisohumulones is greater than 90%.

33. The method of claim 1, wherein the resulting tetrahydroisohumulone composition is a suitable additive for bitter flavor in beer brewing processes.

34. A purified tetrahydroisohumulone composition obtained by the method of claim 1.

35. A method of preparing a tetrahydroisohumulone composition, comprising the steps of:
a. adding a lower alcohol solvent to an aqueous solution containing isohumulones and adjusting the pH to 7.5-11 with an alkaline solution;
b. adding 2-7% by dry mass, relative to the mass of isohumulones, of a supported noble metal hydrogenation catalyst;
c. stirring in the presence of 15-100 psig of hydrogen gas at a temperature of 35-60° C. for 1-6 hours;
d. releasing hydrogen pressure and recovering the reaction solution by removing the hydrogenation catalyst via filtration;
e. removing the alcohol solvent from the reaction solution and concentrating the solution comprising tetrahydroisohumulones through distillation; and
f. adjusting the pH and concentration of the tetrahydroisohumulone solution with an aqueous alkaline solution to a final pH of 9.0-11.0 and to a desired concentration while stirring.

36. A method of preparing a tetrahydroisohumulone composition, comprising the steps of:
a. adding a lower alcohol solvent to a composition of isohumulones in their free acid form;
b. adding 2-7% by dry mass, relative to the mass of isohumulones, of a supported noble metal hydrogenation catalyst to the alcohol solution of isohumulones;
c. stirring the solution in the presence of 15-100 psig of hydrogen gas at a temperature of 35-60° C. for 1-7 hours;
d. releasing hydrogen pressure and recovering the reaction solution by removing the hydrogenation catalyst via filtration;
e. removing the alcohol solvent from the reaction solution comprising tetrahydroisohumulones through distillation; and
f. forming an aqueous solution of tetrahydroisohumulones in salt form by adding water to the tetrahydroisohumulones, heating, and adding an aqueous alkaline solution to a final pH of 9.0-11.0 while stirring.
